(19) United States
(12) Patent Application Publication
(10) Pub. No.: US 2019/0394288 A1
(43) Pub. Date: Dec. 26, 2019

(54) SERVICE PROVIDING SYSTEM AND SERVICE PROVIDING METHOD

(71) Applicant: KONICA MINOLTA, INC., Tokyo (JP)

(72) Inventor: Kazuma MARUYAMA, Hino-shi, Tokyo (JP)

(73) Assignee: KONICA MINOLTA, INC., Tokyo (JP)

(21) Appl. No.: 16/434,380

(22) Filed: Jun. 7, 2019

(30) Foreign Application Priority Data
Jun. 25, 2018 (JP) 2018-120023

(51) Int. Cl. H04L 29/08

(52) U.S. Cl. CPC H04L 67/22; H04L 67/16; H04L 67/34; H04L 67/2823; H04L 67/125

(57) ABSTRACT

A service providing system includes: an information processing device; and a service providing server that provides predetermined service to the information processing device, the service providing server connected to the information processing device via a network, wherein the information processing device includes: a data collector that collects and accumulates data related to a use state; a data transmitter that transmits the data to the service providing server; a cooperation establisher that performs processing of a trial and a main agreement of the service; and a service executer that executes the service provided, by the service providing server, and the service providing server includes: a cooperation establisher that perform the processing of the trial and the main agreement of the service; a database that acquires and accumulates the data; a data processor that executes the service; and an outputter that transmits service information to the information processing device.

The entire disclosure of Japanese patent Application No. 2018-120023, filed on Jun. 25, 2018, is incorporated herein by reference in its entirety.

### Background

### Technological Field

The present invention relates to a service providing system and a service providing method, and in particular to a service providing system and a service providing method for providing service that requires utilization of a data history.

### Description of the Related art

As service that can be provided concomitantly with a device that a user is using, there is service in which data such as a use state in the device is collected, the use state of the device is analyzed on the basis of the collected result, and the appropriate use manner, an efficient usage, etc. of the device are notified on the basis of the analysis result.

For example, conceivable is service in which data of the use state of a certain device is collected, a time when it is necessary to replace consumables of the device is predicted from the use state, and the predicted result is notified to the user.

Considering that such service is provided for a fee, the service provider will be able to predict the time for replacement or the like when a certain amount of information is collected after the user has subscribed the service and collection of data of the use state of the corresponding device has started. That is, immediately after the user has subscribed the service, it is difficult for the service provider to perform correct prediction.

Meanwhile, in the case where fee-based service is provided, it is widely and commonly practiced to set a trial period for providing the service for free for a certain period of time in order to promote the use of the service. Although the trial period varies depending on the type of service, it is generally two weeks to one month.

For example, JP 2014-164392 A discloses that an application that provides service is introduced to a user and that the application is downloaded from an external server to a user terminal as a trial application. In the case of the technology described in JP 2014-164392 A, a service provider monitors whether the operation is within the range of trial conditions.

As described above, setting a trial period for service provided for a fee allows a user to determine whether it is appropriate to subscribe the corresponding service from the service provision state during the trial period. However, for services that cannot be provided unless data is collected for a long period of time such as a replacement time of consumables of the device, even when a trial period is set, there is a high probability that data can be collected to the extent that the service can be appropriately provided to the user within the trial period.

Therefore, there is a disadvantage that although the trial period is originally set to promote subscription to fee-based service, in the short trial period such as one month, it is difficult to receive the service provision to the extent that the value of the service can be understood, which ultimately does not lead to promotion of subscription of the fee-based, service.

### SUMMARY

An object of the present invention is to provide a service providing system and a service providing method that are capable of properly providing service even in a trial period in a case where service, requiring utilization of a data history, is provided and guiding from the trial period to subscription of the service.

To achieve the abovementioned object, according to an aspect of the present invention, a service providing system reflecting one aspect of the present invention comprises: an information processing device; and a service providing server that provides predetermined service to the information processing device, the service providing server connected to the information processing device via a network, wherein the information processing device comprises; a data collector that collects and accumulates data related to a use state which may be used in the service; a data transmitter that transmits the data collected and accumulated by the data collector to the service providing server on a basis of approval by a user; a cooperation establisher that performs processing of a trial and a main agreement of the service with the service providing server; and a service executer that executes the service provided by the service providing server when the cooperation establisher performs processing of the trial or the main agreement of the service, and the service providing server comprises: a cooperation establisher that performs the processing of the trial and the main agreement of the service in the information processing device; a database that acquires and accumulates the data accumulated in the data collector of the information processing device and transmitted by the data transmitter; a data processor that executes the service by using the data accumulated by the database including data before the trial or the main agreement; and an outputter that transmits service information, which is a result of the execution in the data processor, to the information processing device subjected to the approval of the trial or the main agreement.

### BRIEF DESCRIPTION OF THE DRAWINGS

The advantages and features provided by one or more embodiments of the invention will become more fully understood from the detailed description given hereinbelow and the appended drawings which are given by way of illustration only, and thus are not intended as a definition of the limits of the present invention:

FIG. 1 is a block diagram illustrating an exemplary system configuration according to an embodiment of the present invention;

FIG. 2 is a configuration diagram illustrating a multifunctional peripheral and a service provider according to an embodiment of the present invention;

FIG. 3 is a flowchart illustrating a flow of processing (before a service agreement) of color management service according to an embodiment of the present invention;

FIG. 4 is a flowchart illustrating a flow of processing (under a service agreement) of color management service according to an embodiment of the present invention;

FIG. 5 is a diagram illustrating an exemplary screen of terms of use according to an embodiment of the present invention;

FIG. 6 is a diagram illustrating an example of (Example 1) of a service providing screen according to an embodiment of the present invention;

FIG. 7 is a diagram illustrating an example (Example 1) of a service providing screen according to an embodiment of the present invention; and

FIG. 8 is a flowchart illustrating a flow of processing of failure prediction service according to an embodiment of the present invention.

### DETAILED DESCRIPTION OF EMBODIMENTS

Hereinafter, one or more embodiments of the present invention (hereinafter referred to as “present embodiment”) will be described with reference to the drawings. However, the scope of the invention is not limited to the disclosed embodiments.

[1. Exemplary System Configuration]

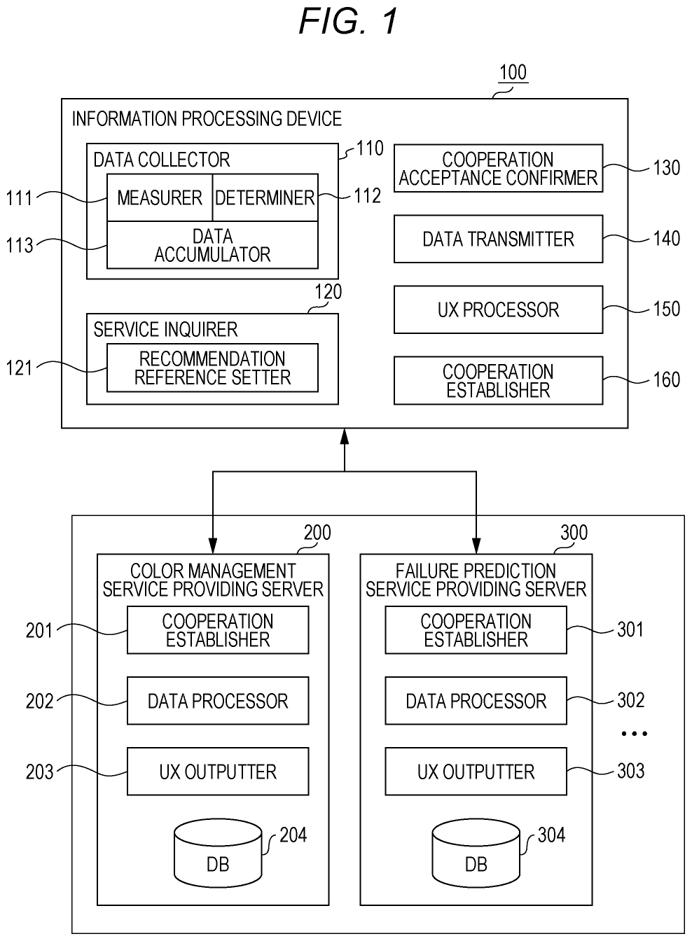

FIG. 1 is a diagram illustrating the overall configuration of a service providing system of this example.

In the service providing system of this example, an information processing device 100 communicates with a color management service providing server 200 and a failure prediction service providing server 300 and receives service provision from the both servers 200 and 300. The information processing device 100, the color management service providing server 200, and the failure prediction service providing server 300 are connected via a predetermined network.

The information processing device 100 of this example is applied to an image forming apparatus which is a multifunction peripheral (MFP) that performs printing on a paper and the like. The color management service providing server 200 executes service of color management upon image formation. The failure prediction service providing server 300 executes failure prediction service of the information processing device (image forming apparatus) 100. The services provided by the color management service providing server 200 and the failure prediction service providing server 300 are provided for fees and are not available unless the user of the information processing device 100 concludes the main agreement or a trial agreement. However, in the case of this example, in the case where the user of the information processing device 100 accepts, even in the situation where the main agreement or the trial agreement has not been concluded, data can be uploaded from the information processing device 100 to the color management service providing server 200 and the failure prediction service providing server 300.

In the information processing device 100 of FIG. 1, only the components that are related to the color management service and the failure prediction service are illustrated.

That is, the information processing device 100 includes a data collector 110, a service inquirer 120, a cooperation acceptance confirmer 130, a data transmitter 140, a user experience processor (hereinafter referred to as “UX processor”) 150, and a cooperation establisher 160.

The data collector 110 includes a measurer 111, a determiner 112, and a data accumulator 113 and performs data collecting processing. The measurer 111 measures the state of respective components when image forming operation is performed as well as a result of the image formation. As one of items measured by the measurer 111, there is a colorimetric function of measuring a color image formed on a paper. The determiner 112 determines whether each of the items measured by the measurer 111 is appropriate. The data accumulator 113 accumulates data measured by the measurer 111 and data of the results determined by the determiner 112.

The service inquirer 120 performs processing of inquiring services that can be provided by the information processing device 100. In this case, the service inquirer 120 includes a recommendation reference setter 121 and determines whether the state of measurement data in the measurer 111 and the determination result by the determiner 112 exceed the recommendation reference set by the recommendation reference setter 121. In the case where it is determined that the recommendation reference has been exceeded, the service inquirer 120 performs processing of introducing a trial of corresponding service to the user of the information processing device 100. This service is introduced, for example, by being displayed on a display (not illustrated) included in the information processing device 100.

The cooperation acceptance confirmer 130 performs processing of confirming cooperation approval with the color management service providing server 200 or the failure prediction service providing server 300. Specifically, the cooperation acceptance confirmer 130 confirms whether there is approval for uploading to the servers 200 and 300, and in the case where there is approval, data collected or data accumulated by the data collector 110 is transmitted from the data transmitter 140 to the servers 200 and 300 as necessary.

The data transmitter 140 performs data transmitting processing on the data collected or the data accumulated by the data collector 110.

The UX processor 150 performs operation of the information processing device 100 or execution of various types of services by providing information necessary for the user by displaying on a display or by other means and accepting operation by the user based on the display on an operation panel.

The cooperation establisher 160 establishes a cooperation state with the servers 200 and 300 so as to enable data exchange with the color management service providing server 200 and the failure prediction service providing server 300.

The color management service providing server 200 includes a cooperation establisher 201, a data processor 202, a user experience outputter (hereinafter referred to as “UX outputter”) 203, and a database 204.

In order to enable data exchange with the information processing device 100, the cooperation establisher 201 performs cooperation building processing of building a cooperation state with the information processing device 100.

The data processor 202 acquires data necessary for the color management service from the database 204 and performs data analysis processing to execute processing of the color management service.

The UX outputter 203 generates a color management service report or the like for performing service available to the information processing device 100 on the basis of the data analysis result in the data processor 202 and transmits the generated report to the information processing device 100.

The database 204 performs data accumulating processing of accumulating data transmitted from the information processing device 100. The data accumulated in the database 204 in this example includes data acquired from the information processing device 100 that the user has approved in addition to data acquired from the information processing device 100 for which a trial agreement or the main agreement has been concluded.

The failure prediction service providing server 300 includes a cooperation establisher 301, a data processor 302, a UX outputter 303, and a database 304.

The failure prediction service providing server 300 has different service contents from those of the color management service providing server 200. That is, what is different from the color management service providing server 200 is that the data processor 302 performs execution processing of failure prediction service and that the UX outputter 303 generates a failure prediction service report and transmits the report to the information processing device 100. The same also applies that data accumulated by the database 304 also includes data from the information processing device 100 without a trial agreement or the main agreement.

[2. Overview of Color Management Service]

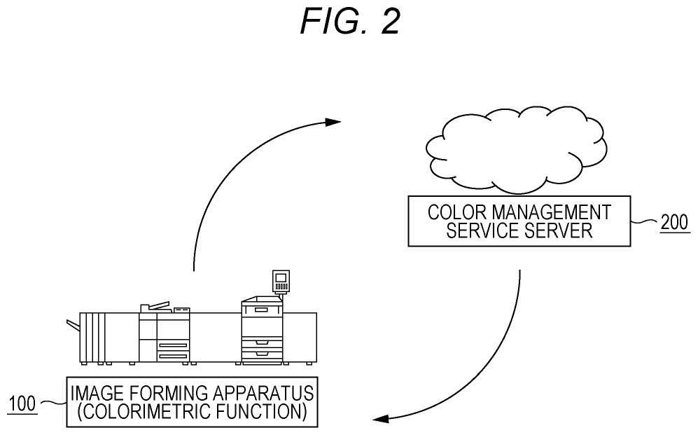

FIG. 2 illustrates an image in a state where the information processing device (image forming apparatus) 100 communicates with the color management service providing server 200 to acquire the color management service. The information processing device IOU which is the image forming apparatus is attached with a colorimeter, which measures colors of a formed image, and measures the color formation state of the formed image by the colorimetric function of the colorimeter and stores the measurement data in the information processing device 100. The measurement data can also be transmitted to the color management service providing server 200.

Meanwhile, the color management service providing server 200 acquires and accumulates colorimetric data and other data, analyzes a change in the colorimetric state, predicts a timing at which color adjustment in the information processing device 100 is required, and generates a service report notifying the predicted timing at which color adjustment is required. Then, the generated service report is transmitted to the information processing device 100 and displays the service report on the display of the information processing device 100. Alternatively, the service report may be printed by the printing function of the information processing device 100. Further alternatively, the service report may be transmitted to a terminal (a computer that the user is using, for example) different from the information processing device 100 which is the image forming apparatus.

Explaining more precisely about the color management service here, in a case where there is a severe requirement for the colors of printed matters such as in a printing office, an important point is whether colors desired by the user are correctly printed on printed matters obtained by the image forming apparatus.

Therefore, the user prints a colorimetric chart, which is defined as a standard, using the image forming apparatus and measures the chart by using the colorimetric function attached to the image forming apparatus to compare and to determine whether the chart is printed in accordance with the standard or as desired by the user.

In the case where the result is “no problem found (OK)” in such determination, printing can be started promptly; however in a case where the printing result of the chart is not as desired by the user, it is necessary to perform color adjustment of the image forming apparatus and to adjust the printing status of the colors. Generally in a printing office, this work is performed periodically (that is, for every certain period of time) as daily management.

However, in many cases, a printing office has a plurality of image forming apparatuses, and upon operation which printing material to print is determined each day for each of the image forming apparatuses. Therefore, when the colors of a certain image forming apparatus suddenly go wrong, there are cases where color adjustment of the image forming apparatus is performed, or without the color adjustment, the printing is performed by another image forming apparatus, or in the worst case, delivery of the printed materials is delayed.

In this example, since using the color management service provided by the color management service providing server 200 allows the timing at which color adjustment is necessary to be grasped in advance on the basis of the result of colorimetric measurements of daily management, which allows the user to improve the efficiency of work.

However, in such service, the timing of color adjustment cannot be predicted unless a certain number of pieces of data is collected, and thus it is necessary for the user to use the service to some extent in order to determine its utility value.

When the color management service providing server 200 provides the service, a trial period of about several weeks is set to allow the user to recognize the utility value of the service within the trial period. Then, with conclusion of the main agreement, a full-scale use of the corresponding color management service starts.

In the case of the color management service, correct prediction cannot be performed unless colorimetric data of the information processing device (image forming apparatus) 100 is accumulated for a certain period of time. Here, in the case of this example, the color management service providing server 200 acquires and accumulates colorimetric data from the information processing device 100 in a case where the user approves even before the trial or the main agreement. Therefore, in the case of the information processing device 100 subjected to the user's approval, the timing of color adjustment can be accurately predicted even within the trial period, which allows the user to correctly recognize the utility value of the service.

[3. Flow of Color Management Service]

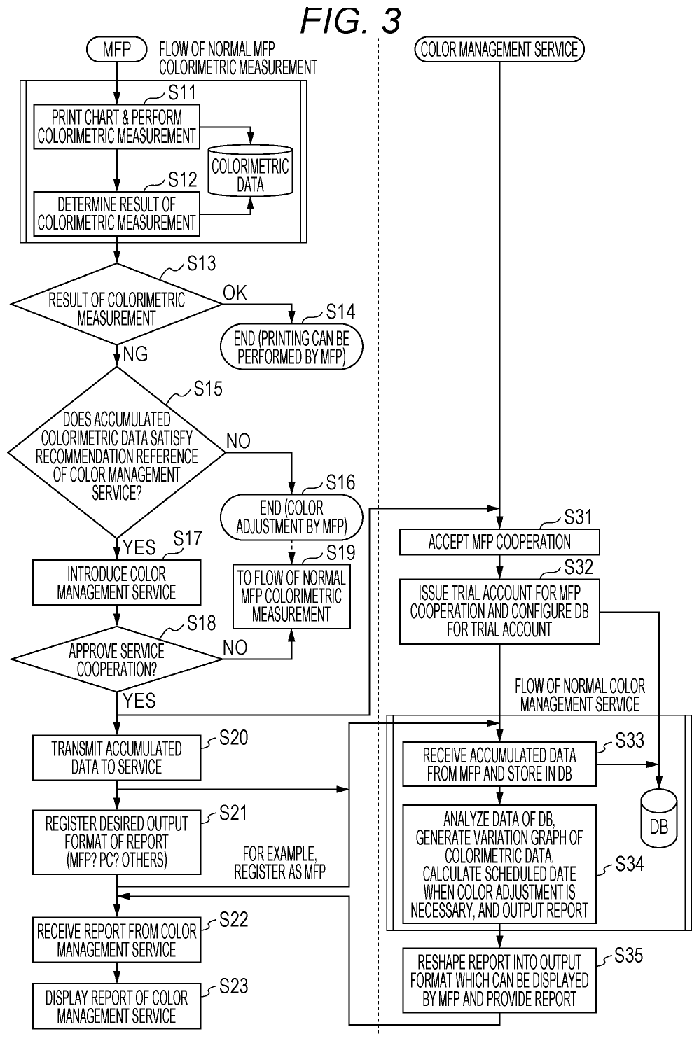

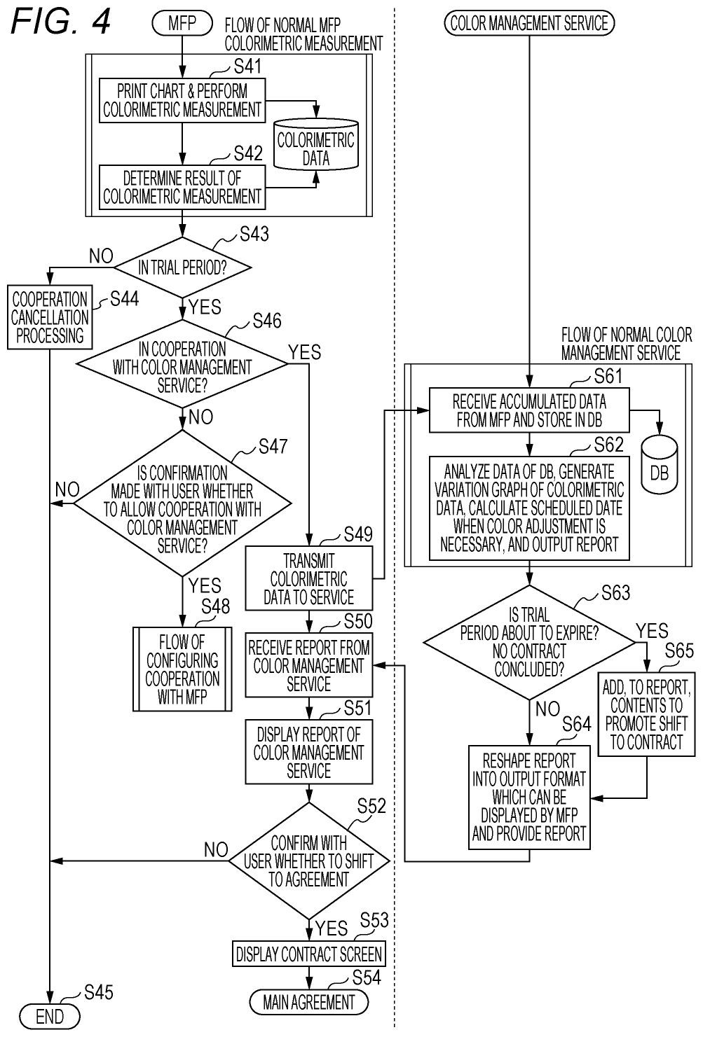

Next, the flow of processing when the color management service providing server 200 of this example provides the color management service will be described with reference to FIGS. 3 and 4.

The flowchart of FIG. 3 illustrates a processing example at the start of the use of the color management service. Processing of steps S11 to S23 on the left side of FIG. 3 is performed in the information processing device (image forming apparatus (MFP)) 100, whereas processing of steps S31 to S35 on the right side of FIG. 3 is performed in the color management service providing server 200.

First, the information processing device 100 prints a colorimetric chart by operation by the user, the data collector 110 collects colorimetric data, and the data accumulator 113 stores the collected colorimetric data (step S11). Then the determiner 112 determines the color adjustment result on the basis of the collected colorimetric data, and the data accumulator 113 stores the determination result (step S12).

Then, the information processing device 100 determines whether the colorimetric determination result in step S12 is an appropriate colorimetric state (OK) nor inappropriate (NG) (step S13). If the colorimetric state is appropriate (OK in step S13), it is determined that printing can be performed in the corresponding information processing device 100, and the colorimetric processing is terminated (step S14).

If the colorimetric determination result is inappropriate in step S13 (NG in step S13), the service inquirer 120 of the information processing device 100 determines whether the calorimetric determination result satisfies the recommendation reference set by the recommendation reference setter 121 (step S15). Here, if the recommendation reference is not satisfied (No in step S15), color adjustment of the information processing device 100 is performed by operation by the user to allow appropriate printing, and the calorimetric processing is terminated (step S16).

On the other hand, if the recommendation reference is satisfied in step S15 (Yes in step S15), the information processing device 100 introduces the color management service provided by the color management service providing server 200 to the user by displaying on the display or the like (step S17).

In this introductory message, the user is inquired whether to approve cooperation with the color management service, and the information processing device 100 determines whether there is approval to cooperation with the color management service (step S18).

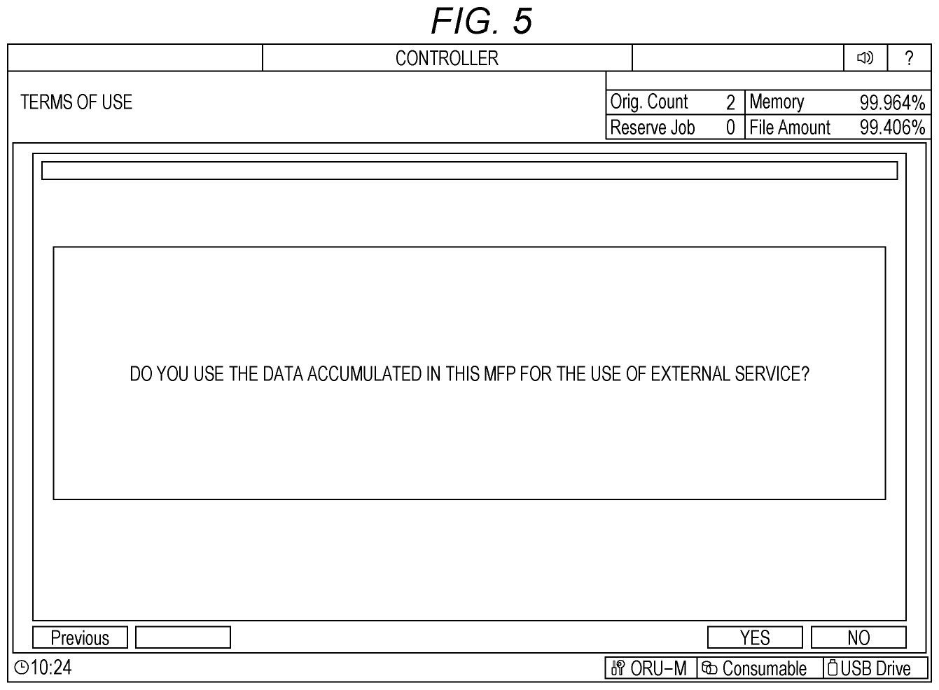

FIG. 5 is a diagram illustrating an exemplary displayed screen requesting approval to cooperation with the color management service.

In the example of FIG. 5, a message of “Do you use the data accumulated in this MFP for the trial use of external service?” is displayed on the screen, and it is regarded that there is approval by operation of the “YES” button by the user and that there is no approval by operation of the “NO” button by the user

Returning to the explanation of the flowchart of FIG. 3, if the user does not approve the cooperation with the color management service in the determination in step S18 (No in step S18), the flow proceeds to a normal colorimetric processing procedure individually prepared in the information processing device 100 (step S19).

If the user approves the cooperation with the color management service in the determination of step S18 (Yes in step S18), the information processing device 100 notifies the color management service providing server 200 that the cooperation has been approved. Upon receiving this notification, the color management service providing server 200 accepts cooperation with the information processing device 100 (step S31), issues a trial account of the color management service, and configures a database for the trial account to be executed in the trial account (step S32).

Then, the information processing device 100 transmits the data accumulated by the data accumulator 113 to the color management service providing server 200 (step S20). The cooperation with the color management service results in conclusion of a trial agreement, and a trial period starts.

After transmission of the accumulated data in step S20, the information processing device 100 registers an output format of a received report in the color management service providing server 200 (step S21). Output formats of reports include, for example, a format that the information processing device 100 itself receives and prints a report and a format in which a separate terminal other than the information processing device 100 receives and displays a report. In this example, it is assumed that registration is made that the information processing device 100 receives and displays a report.

On the color management service providing server 200 side, the data transmitted in step S20 is stored in the database configured in step S32 (step S33).

Then, the data processor 202 of the color management service providing server 200 analyzes the data by using the stored data, generates a variation graph of the colorimetric data, calculates a scheduled date when color adjustment is necessary, creates a report listing the variation graph and the scheduled date, and outputs the created report (step S34). The UX outputter 203 of the color management service providing server 200 further reshapes the report into data of a format that can be output by the information processing device 100 and provides the report to the information processing device 100 (step S35).

The report from the color management service providing server 200 is received by the information processing device 100 (step S22), and for example the display of the information processing device 100 displays the report (step S23).

FIG. 4 is a flowchart illustrating processing after the trial period has started. Also in FIG. 4 like in FIG. 3, processing of steps S41 to S54 on the left side is performed in the information processing device (image forming apparatus (MFP)) 100, whereas processing of steps S61 to S65 on the right side is performed in the color management service providing server 200.

First, the information processing device 100 prints a colorimetric chart by operation by the user, the data collector 110 collects colorimetric data, and the data accumulator 113 stores the collected colorimetric data (step S41). Then the determiner 112 determines the color adjustment state on the basis of the collected colorimetric data, and the data accumulator 113 stores the determination result (step S42).

Next, the information processing device 100 determines whether it is currently in a trial period of the color management service (step S43). If the trial period has passed and the trial period has expired (No in step S43), the cooperation establisher 160 performs cooperation cancellation processing with the color management service providing server 200 (step S44) and terminates the processing (step S45).

On the other hand, if it is determined in step S43 that the trial period is ongoing (Yes in step S43), the information processing device 100 determines whether there is cooperation with the color management service (step S46). If there is no cooperation with the color management service (No in step S46), the information processing device 100 confirms whether to enable cooperation with the color management service (step S47). If there is an instruction for cooperation with the color management service (Yes in step S47), the information processing device 100 performs cooperation processing with the color management service (step S48).

Alternatively if there is an instruction not to enable cooperation with the color management service in step S47 (No in step S47), the information processing device 100 terminates the processing (step S45).

Then in step S46, if it is determined that cooperation with the color management service is ongoing (Yes in step S46), the information processing device 100 transmits colorimetric data to the color management service providing server 200 (step S49).

On the color management service providing server 200 side, the data transmitted in step S49 is stored in the database (step S61).

Then, the data processor 202 of the color management service providing server 200 analyzes the data by using the stored data, generates a variation graph of the colorimetric data, calculates a scheduled date when color adjustment is necessary, creates a report listing the variation graph and the scheduled date, and outputs the created report (step S62).

Then, the color management service providing server 200 determines whether the trial period of the information processing device 100 of the created report is about to expire and the main agreement has not yet been concluded (step S63). If the trial period is about to expire and the main agreement has been concluded (No in step S63), the UX outputter 203 of the color management service providing server 200 The UX reshapes the color management report into data of a format that can be output by the information processing device 100 and provides the color management report to the information processing device 100 (step S64).

If the trial period is about to expire and the main agreement has not yet been concluded in step S63 (Yes in step S63), contents to promote a shift to the contract is added to the color management report provided in step S64 (step S65).

The report from the color management service providing server 200 is received, by the information processing device 100 (step S50), and for example a display of the color management service providing server 200 displays the report (step S51).

Then, the information processing device 100 confirms the user whether to shift to the main agreement (step S52). If not shifting to the main agreement (No in step S52), the information processing device 100 terminates the processing (step S45).

On the other hand, if shifting to the main agreement (Yes in step S52), the display of the information processing device 100 displays a contract screen (step S53), and the main agreement is processed on the basis of the operation on the contract screen (step S54).

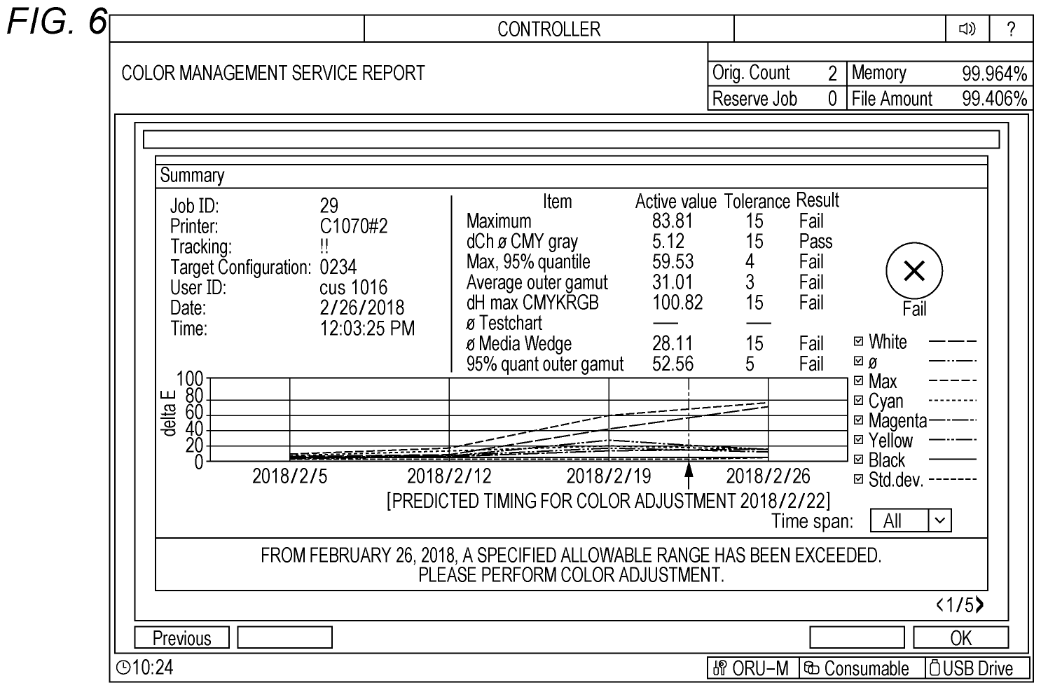

FIG. 6 illustrates a report displayed immediately after cooperation with the color management service.

In this service report, a graph generated by the color management service on the basis of the accumulated data and an analysis result sample by the color management service are displayed.

The graph illustrates a list of measured values and calculated values and how much these values deviate from reference values, as well as the transition of the values.

As the analysis result sample, an example of a text message is illustrated warning that “From Feb. 26, 2018, a specified allowable range has been exceeded. Please perform color adjustment.”

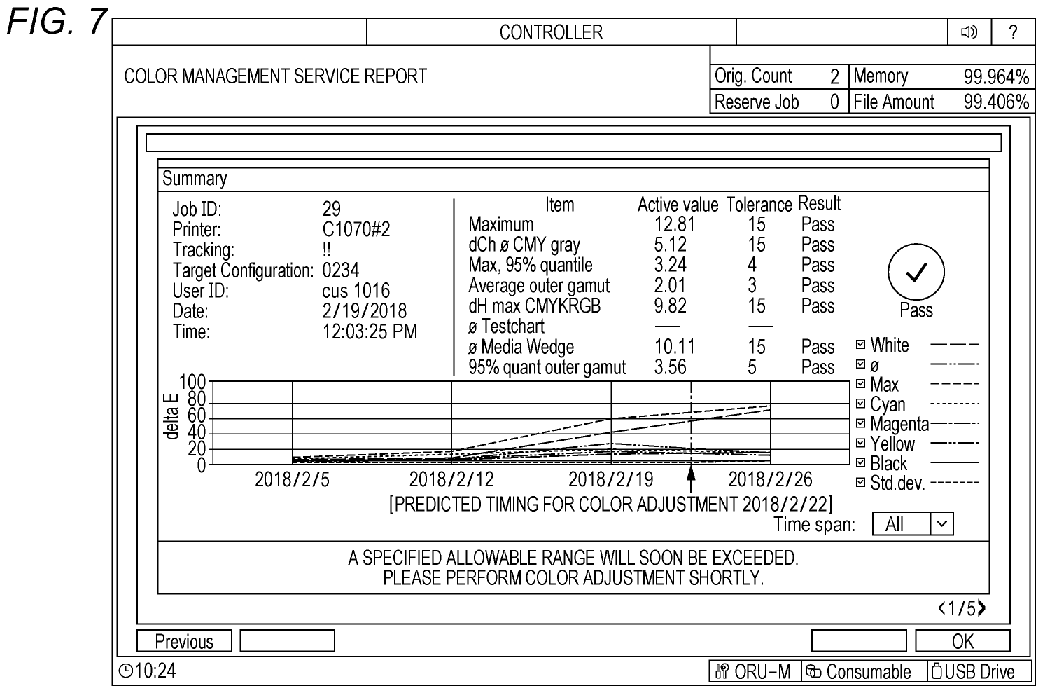

FIG. 7 illustrates an exemplary color management service report after cooperation.

A graph similar to that in FIG. 6 is displayed including the current colorimetric values, prediction of future colorimetric values, and a timing when color adjustment is to be performed as a “predicted tinting of color adjustment.” Notification is displayed such as “A specified allowable range will soon be exceeded. Please perform color adjustment shortly.”

When such a report of the color management service is displayed, the user can understand the timing when color adjustment is necessary and can realize the advantage of subscribing to the color management service. At the start of a normal trial, no data is accumulated and thus the advantage of the service cannot be exercised at all; however in this example, utilization of past data at the time of the start of the trial dated Feb. 19, 2018 allows a graph, prediction of color adjustment timing, etc. of the color management service to be provided to the user.

[4. Flow of Failure Prediction Service]

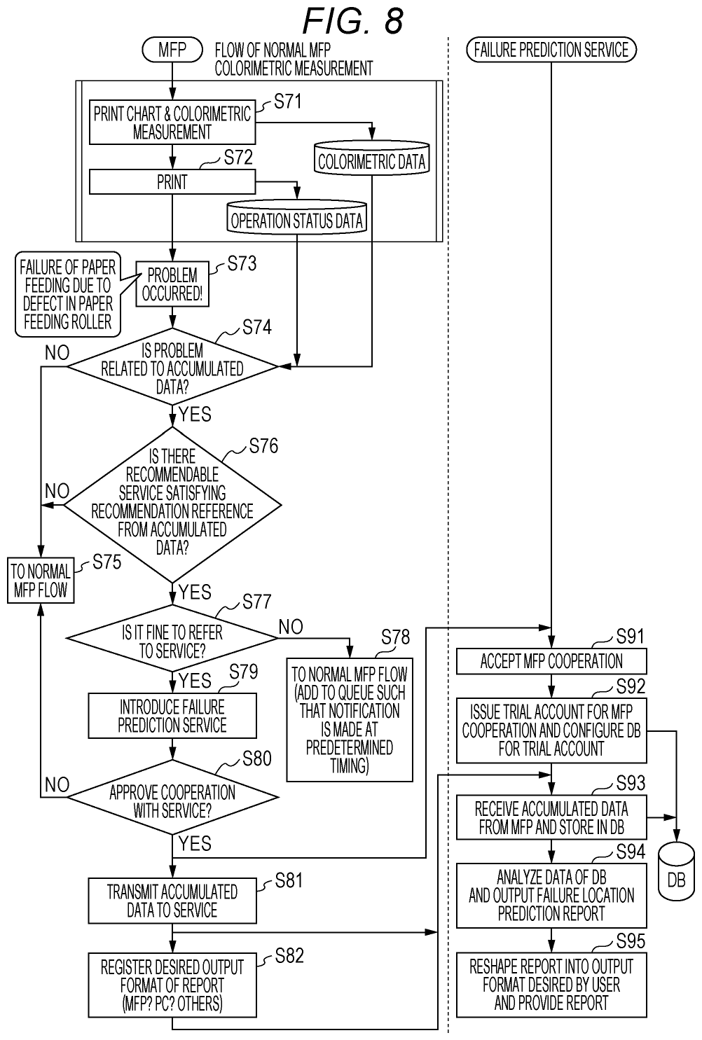

Next, the flow of processing when the failure prediction service providing server 300 of this example provides the failure prediction service will be described with reference to FIG. 8.

A flowchart of FIG. 8 illustrates exemplary processing of the failure prediction service. Processing of steps S71 to S82 on the left side of FIG. 8 is performed in the information processing device (image forming apparatus (MFP)) 100, whereas processing of steps S91 to S95 on the right side of FIG. 8 is performed in the failure prediction service providing server 300.

First, the information processing device 100 prints a colorimetric chart by operation by the user, the data collector 110 collects colorimetric data, and the data accumulator 113 stores the collected colorimetric data (step S71). Then the printing starts, the data collector 110 collects operation status data, and the data accumulator 113 stores the collected operation status data (step S72).

It is assumed that thereafter some problem has occurred in the information processing device 100 (step S73). For example, it is assumed that a failure of paper feeding has occurred due to a defect in a paper feeding roller.

At this time, the information processing device 100 refers to the data stored in the data accumulator 113 and determines whether the problem occurred is related to the accumulated data (step S74). In this determination, if there is no relation to the accumulated data (No in step S74), the flow proceeds to a processing procedure for a normal failure of the image forming apparatus (step S75).

If there is relation to the accumulated data in the determination of step S74 (Yes in step S74), the information processing device 100 determines from the accumulated data whether there is recommendable service satisfying the recommendation reference (step S76).

Here, if there is no recommendable service satisfying the recommendation reference (No in step S76), the flow proceeds to a processing procedure for a normal failure of the image forming apparatus (step S75).

If there is recommendable service satisfying the recommendation reference in the determination of step S74 (Yes in step S76), it is determined whether introduction of the corresponding service is possible (step S77).

If no service can be introduced in step 577 (No in step S77), the flow proceeds to a processing procedure for a normal failure of the image forming apparatus (step S78). Note that, in this example, a notification is added to a queue such that the notification is made at a predetermined timing.

Alternatively, if service can be introduced in step S77 (Yes in step S77), the information processing device 100 introduces corresponding failure prediction service by displaying on the display or other means (step S79).

In this introductory message, the user is inquired whether to approve cooperation with the failure prediction service, and the information processing device 100 determines whether there is approval to cooperation with the failure prediction service (step S80).

If the user does not approve cooperation with the failure prediction service in the determination of step S80 (No in step 580), the flow proceeds to a processing procedure for a normal failure of the image forming apparatus (step S75).

If the user approves the cooperation with the failure prediction service in the determination of step S80 (Yes in step S80), the information processing device 100 notifies the failure prediction service providing server 300 that the cooperation has been approved.

Upon receiving this notification, the failure prediction service providing server 300 accepts cooperation with the information processing device 100 (step S91), issues a trial account of the failure prediction service, and configures a database for the trial account to be executed in the trial account (step S92).

Then, the information processing device 100 transmits the data accumulated by the data accumulator 113 to the failure prediction service providing server 300 (step S81). The cooperation with the failure prediction service providing server 300 results in conclusion of a trial agreement, and a trial period starts.

After transmission of the accumulated data in step S81, the information processing device 100 registers an output format of a received report in the failure prediction service providing server 300 (step S82),

On the failure prediction service providing server 300 side, the data transmitted in step S81 is stored in the database configured in step S92 (step S93).

Then, the data processor 302 of the failure prediction service providing server 300 analyzes the data using the stored data and outputs a failure location prediction report (step S94). The UX outputter 303 of the failure prediction service providing server 300 further reshapes the report into data of a format that can be output by the information processing device 100 and provides the report to the information processing device 100 (step S95).

The report from the failure prediction service providing server 300 is received by the information processing device 100, and for example the display of the information processing device 100 displays the report.

As described above, even in the case of the failure prediction service, prediction of a failure location is enabled in the trial period by using data before the trial period, and an appropriate report can be presented to the user.

Note that in the case of the failure prediction report, a scheduled date of maintenance, an estimate of machine support request based on failure prediction, or the like may be added to the report.

[5. Variations]

Note that in the case where the information processing device recommends, either of the two cases may be implemented where the trial period is not started unless the user accepts so even though the recommendation reference is satisfied and where the trial period is started automatically.

Moreover, depending on the state of the information processing device, even when the recommendation reference is satisfied, the service may not be promptly introduced, but introduced at a predetermined timing.

Furthermore, although the example has been described in which an execution result of the service is displayed on the information processing device; however in the case where another computer device or the like displays, the result may be transmitted in a format suitable for display on that device.

During the trial period of the service, the data, may be sequentially transmitted to the service, and a result of the service may be sequentially updated at the start together with the batch of data having been transmitted.

Furthermore, when the trial period expires, the cooperation between the information processing device and the service may be automatically disconnected.

Alternatively, when the trial period expires, processing of shifting to the main agreement may be executed without disconnecting the cooperation between the information processing device and the service. In the case of shifting to the main agreement, the user may be urged to input the contents necessary for the contract.

Furthermore, as the data used by the failure prediction service, not only the use status of the device but also operation information, wear information or other information of mechanical parts may be included.

In the embodiment described above, the examples of the color management service and the failure prediction service have been illustrated; however, other services may be performed.

Furthermore, although the image forming apparatus has been described as an example in the embodiment described above, the present invention is also applicable to other various types of information processing devices.

According to an embodiment of the present invention, since a service providing server collects and accumulates also data before trial or the main agreement, in the case where trial is used, data collected in the past for the corresponding information processing device is used to enable immediate provision of appropriate service. Therefore, a user using the information processing device can appropriately determine what type of service is available from the corresponding service during the trial period, which enables proper guidance from the trial period to subscription of the service.

Although embodiments of the present invention have been described and illustrated in detail, the disclosed embodiments are made for purposes of illustration and example only and not limitation. The scope of the present invention should he interpreted by terms of the appended claims.

What is claimed is:

1. A service providing system comprising: an information processing device; and a service providing server that provides predetermined service to the information processing device, the service providing server connected to the information processing device via a network,
wherein the information processing device comprises:
a data collector that collects and accumulates data related to a use state which may be used in the service;
a data transmitter that transmits time data collected and accumulated by the data collector to the service providing server on a basis of approval by a user;
a cooperation establisher that performs processing of a trial and a main agreement of the service with the service providing server; and
a service executer that executes the service provided by the service providing server when the cooperation establisher performs processing of the trial or the main agreement of the service, and
the service providing server comprises:
a cooperation establisher that performs the processing of the trial and the main agreement of the service in the information processing device;
a database that acquires and accumulates the data accumulated in the data collector of the information processing device and transmitted by the data transmitter;
a data processor that executes the service by using the data accumulated by the database including data before the trial or the main agreement; and
an outputter that transmits service information, which is a result of the execution in the data processor, to the information processing device subjected to the approval of the trial or the main agreement.

2. The service providing system according to claim 1,
wherein the information processing device performs introduction processing of the service.

3. The service providing system according to claim 2,
wherein the introduction processing is performed in the data processor when a result of execution of the service in the information processing device without the trial nor the main agreement satisfies a predetermined recommendation reference.

4. The service providing system according to claim 1,
wherein the information processing device is an image forming apparatus having a colorimetric function for measuring an image formed, and
the service is color management service of an image formed by the image forming apparatus.

5. The service providing system according to claim 4,
wherein the color management service is to predict a schedule of color adjustment from a varying state of a result of colorimetric measurement by the colorimetric function.

6. The service providing system according to claim 1,
wherein the information processing device is an image forming apparatus, and
the service is failure prediction service of the image forming apparatus.

7. A service providing method for a service providing server to provide predetermined service to an information processing device,
wherein the information processing device performs;
collecting and accumulating data which may be used in the service;
transmitting the data collected and accumulated in the collecting and the accumulating to the service providing server on a basis of approval by a user;
performing processing of a trial and a main agreement of the service with the service providing server; and
executing the service provided by the service providing server when the trial or the main agreement of the service is performed in the performing processing of a trial and a main agreement, and
the service providing server performs:
performing the processing of the trial or the main agreement of the service in the information processing device;
accumulating the data transmitted by the information processing device;
executing the service by using the data accumulated in the accumulating including data before the trial or the main agreement; and
transmitting service information, which is a result of the executing, to the information processing device subjected to the trial or the main agreement.
